(19) United States
(12) Patent Application Publication
(10) Pub. No.: US 2013/0066666 A1
(43) Pub. Date: Mar. 14, 2013

(54) Enhancing Performance of Crops Within An Area of Interest

(71) Applicants: John Richard Anderson, JR., Raleigh, NC (US); Jon James Fridgen, Tolono, IL (US); Earl L. Burkybile, Pacific, MO (US); Gregory E. Knoblauch, St. Charles, MO (US); Marcus E. Jones, Ballwin, MO (US); Michael Wayne Twenhafel, New Baden, IL (US); Kyle Wayne Freeman, Plymouth, MN (US)

(72) Inventors: John Richard Anderson, JR., Raleigh, NC (US); Jon James Fridgen, Tolono, IL (US); Earl L. Burkybile, Pacific, MO (US); Gregory E. Knoblauch, St. Charles, MO (US); Marcus E. Jones, Ballwin, MO (US); Michael Wayne Twenhafel, New Baden, IL (US); Kyle Wayne Freeman, Plymouth, MN (US)

(73) Assignee: MONSANTO TECHNOLOGY LLC, St. Louis, MO (US)

(21) Appl. No.: 13/522,923

(22) PCT Filed: Jan. 21, 2011
(86) PCT No.: PCT/US11/22092

§ 371 Date: Nov. 15, 2012

Related U.S. Application Data
(60) Provisional application No. 61/297,545, filed on Jan. 22, 2010.

(51) Int. Cl. G06Q 10/06

(52) U.S. Cl. 705/7.12

(57) ABSTRACT

Enhancing crop performance using a computer coupled to a memory, including receiving a plurality of area of interest (AOI) raster files from a remote sensing device via a network, and generating at least one index raster file based on the plurality of AOI raster files. At least one yield zone is defined within the AOI based on the at least one index raster file, and a hybrid and a seed rate are determined for the hybrid for use in planting in the at least one yield zone. A planting recommendation is generated for the AOI based on the hybrid and the seed rate and is delivered to a planter, wherein the planter is configured to plant the at least one yield zone using the hybrid and the seed rate.

### BACKGROUND

At least some known organizational methods have been used in an attempt to systematically select seed products by matching seed products or seeding rates to an environment. For example, these known methods include dividing a grower's field into a plurality of regions based on an environmental profile of each region. The environmental profiles are then used to determine a seed product for each region based on a matrix of interactions between seed products, environmental factors, and management factors. However, such known methods have relied predominantly on anecdotal data and/or manually-acquired soil samples to generate the matrix of interactions. Moreover, such known methods do not use remotely sensed imagery of the area of interest to partition the area of interest into a plurality of yield zones.

### BRIEF DESCRIPTION

In one aspect, a method is provided for enhancing crop performance using a computer coupled to a memory. The method includes receiving a plurality of area of interest (AOI) raster files from a remote sensing device via a network, generating at least one index raster file based on the plurality of AOI raster files, and defining at least one yield zone within the AOI based on the at least one index raster file. The method also includes determining a hybrid and a seed rate for the hybrid for use in planting in the at least one yield zone, generating a planting recommendation for the AOI based on the hybrid and the seed rate, and delivering the planting recommendation to a planter, wherein the planter is configured to plant the at least one yield zone using the hybrid and the seed rate.

In another aspect, a computer coupled to a memory area is provided for use in enhancing crop performance. The computer is programmed to receive a plurality of area of interest (AOI) raster files from a remote sensing device via a network, generate at least one index raster file based on the plurality of AOI raster files, define at least one yield zone within the AOI based on the at least one index raster file, and determine a hybrid and a seed rate for the hybrid for use in planting in the at least one yield zone based on a plurality of population trials. The computer is also programmed to generate a planting recommendation for the AOI based on the hybrid and the seed rate, deliver the planting recommendation to a planter, wherein the planter is configured to plant the at least one yield zone using the hybrid and the seed rate, receive position data of the planter during planting of the hybrid, and store the planting recommendation and the position data in the memory area.

In another aspect, one or more computer-readable storage media having computer-executable components are provided for enhancing crop performance within an area of interest (AOI) using a computer coupled to a memory area. The components include an index component that when executed by at least one processor causes the processor to receive a plurality of AOI raster files from a remote sensing device via a network and generate at least one index raster file based on the plurality of AOI raster files. The components also include a yield zone component that when executed by the processor causes the processor to define at least one yield zone within the AOI based on the at least one index raster file and calculate a yield goal for the at least one yield zone based on a plurality of population trials. Moreover, the components include a planting recommendation component that when executed by the processor causes the processor to determine a hybrid and a seed rate for the hybrid for use in planting in the at least one yield zone based at least in part on the yield goal, generate a planting recommendation for the AOI based on the hybrid and the seed rate, and transmit the planting recommendation to a planter, wherein the planter is configured to plant the at least one yield zone using the hybrid and the seed rate.

In yet another aspect, a system is provided to enhance crop performance within an area of interest (AOI). The system includes a computer system having a memory and a processor coupled to the memory. The computer system coupled to a remote sensing device via network, and is configured to receive a plurality of AOI raster files from a remote sensing device via a network, generate at least one index raster file based on the plurality of AOI raster files, define at least one yield zone within the AOI based on the at least one index raster file, and calculate a yield goal for the at least one yield zone based on a plurality of population trials. The computer system is also configured to determine a hybrid and a seed rate for the hybrid for use in planting in the at least one yield zone based at least in part on the yield goal, generate a planting recommendation for the AOI based on the hybrid and the seed rate, and transmit the planting recommendation to a planter, wherein the planter is configured to plant the at least one yield zone using the hybrid and the seed rate.

### BRIEF DESCRIPTION OF THE DRAWINGS

The embodiments described herein may be better understood by referring to the following description in conjunction with the accompanying drawings.

FIG. 1 is an index-based map in geographic information system (GIS) format and generated using remotely-sensed imagery.

FIG. 2 is a soil slope map in GIS format.

FIG. 3 is a yield distribution derived from data obtained from a plurality of crop population trials for use in calculating a yield goal for a yield zone.

FIG. 4 illustrates integration of an index-based map with a soil slope map to create a plurality of yield zones that each has an associated yield goal.

FIG. 5 a graph that illustrates yield and seeding rate equations that are used to generate a seeding rate recommendation that matches the yield goal for an associated yield zone.

FIG. 6 is a set of graphs for use in analyzing seed product performance at different yield levels.

FIG. 7 is a view of an output screen that displays selected seed products and seeding rates for each yield zone within an area of interest.

FIG. 8 is a view of a drawing tool that enables a user to designate a hopper within a planter for containing a selected seed product.

FIG. 9 is a view of the drawing tool shown in FIG. 8, and that also enables a user to designate a yield zone in which a selected seed product will be planted.

FIG. 10 is a view of an output screen that displays an icon system for linking specific seed product recommendations to agronomic scenarios.

### DETAILED DESCRIPTION

In some embodiments, the term “remote sensing” (RS) refers generally to a non-destructive processor gathering information about an object or area of interest using an electromagnetic sensor or data collection device, while the sensor or device is not in direct physical contact with the object or area. Typical examples of agriculturally significant RS data sources include those collected by cameras on earth-orbiting satellites and aircraft. Numerous kinds of electromagnetic sensors can be used in RS applications, including sensors that collect information about absorbed or reflected electromagnetic radiation, for example, in a single spectral bands, in several multispectral bands, in many hyperspectral bands, in the visible-light region, in the near-infrared region, in the middle-infrared region, in the far-infrared region, and/or in the microwave regions.

In some embodiments, the term “multispectral” (MS) refers generally to a kind of RS system that uses two or more spectral bands. Common RS spectral bands and codes are listed hereinbelow.

Exemplary technical effects of methods, systems, computers, and computer-readable storage media described herein include at least one of: (a) delivering a prescriptive seed recommendation and/or a seeding rate recommendation to a grower or an agronomic advisor via an electronic transmission; (b) providing the recommendations to planting equipment for use in tracking seed location and seed rate within an area of interest; and (c) creating, transmitting, and storing a comprehensive record of the prescriptive recommendations and their implementation within the area of interest for archiving and/or analysis.

Embodiments described herein provide an application for use in enhancing crop yield by transforming massive quantities of proprietary, experimental data related to previous crop population trials into specialized knowledge of seed products and properties of an area of interest. The method uses that specialized knowledge, in combination with remotely-sensed soil and crop data, one or more rule-making matrices, geographic information systems (GIS), and optimization algorithms to perform a number of operations including, but not limited to only including, those described below. Each of the above elements is used to dissect tracts of land within an area of interest used for crop production into a plurality of yield zones that each exhibits a different productivity potential.

As used herein, the term “yield zone” refers generally to a zone within an area of interest that possesses similar crop and soil characteristics, input responses or management approach, and/or measured yields. Each zone has distinctly different yield potential and response to management inputs when compared to other yield zones within the same area of interest.

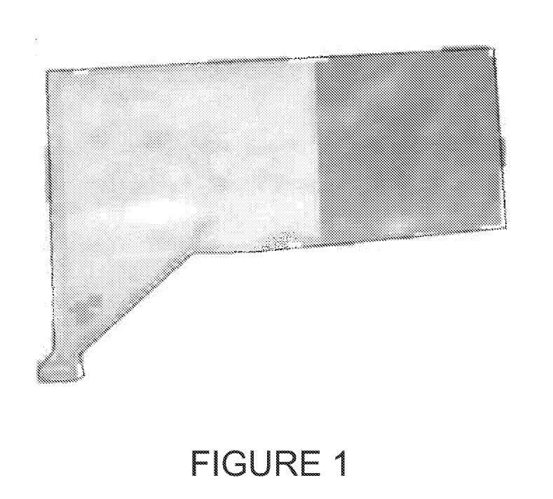

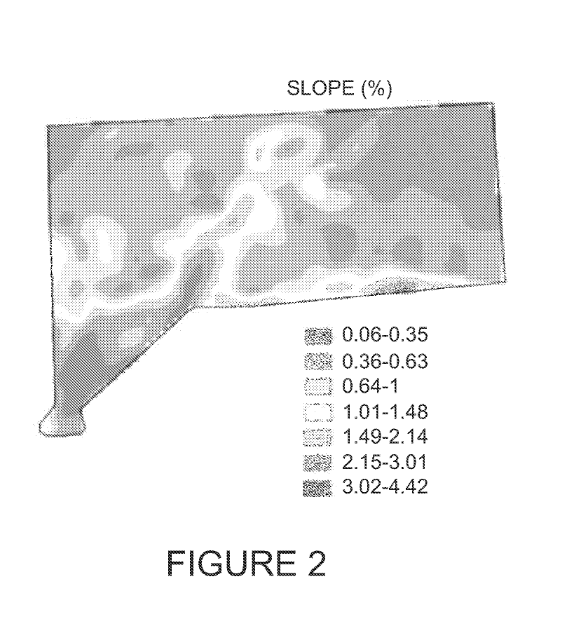

FIG. 1 is a view of an index-based map that is generated using remote-sensed imaging data. FIG. 2 is a view of a soil slope map. The yield zones are created by statistically integrating the index-based map shown in FIG. 1 and the soil slope map shown in FIG. 2. In the exemplary embodiment, the index-based map is a green biomass index (GBI) map. However, any suitable index-based or classification map may be used that is generated using remote-sensed imaging data. Specifically, in some embodiments, the slope components are merged or interpolated with the index-based map. In an alternative embodiment, boundary lines are detected within the index-based map, with or without a slope component. The remote sensing data, i.e., soil brightness classification data and/or green biomass data maps, are derived from multispectral, remote-sensed images generated with a combination of three or more spectral bands. Each yield zone is created based on its unique ability to grow crops and the management knowledge of the grower. For example, each yield zone may be differently managed to maximum advantage. In addition, accrual of incremental harvest data from each yield zone enables an increase in the productivity of a crop within each yield zone and within the area of interest as a whole.

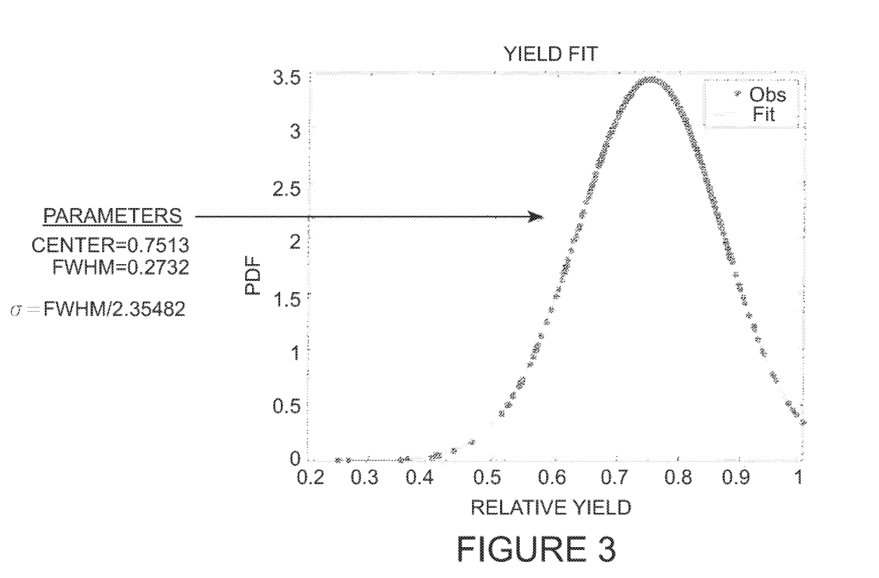

Moreover, variable shading and/or coloring is used to distinguish the yield zones when the area of interest is displayed to an operator or user. The application described herein differs from at least some previously implemented precision agricultural endeavors in that each yield zone is created based on soil brightness classification maps and a slope component, or based on a green biomass index map (GBI) and a slope component. Furthermore, a yield goal is calculated for each yield zone using a yield distribution generated from a plurality of crop population trials, as shown in FIG. 3.

Because the yields obtained during the crop population trials are often higher than farm fields, such as an area of interest as used herein, each yield goal defines a mathematical yield possibility, rather than an aspiration of a grower. The crop population trial data includes, for example and not by way of limitation, disease ratings, susceptibility to drought, susceptibility to stalk and/or root lodging, and/or responses to specific soil fertilization programs and/or soil characteristics.

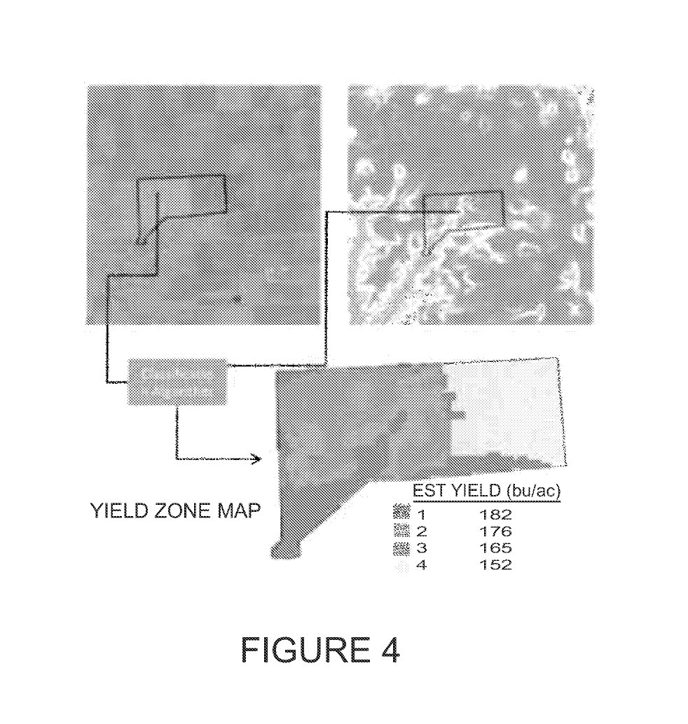

FIG. 4 is an index-based map that has been integrated with a soil slope map to form a map that includes a plurality of yield zones, wherein each of the yield zones has a respective yield goal. The crop population trial data is used to model crop yield distributions such that the productivity goals, or yield goals, may be assigned to the yield zones in a color-coded format. Specifically, boundary parameters within the crop population trial data are used by the application to distribute the yield zones and calculate the yield goal for each yield zone. Simultaneously, the one or more rule-making matrices are used to ensure that seed products are not placed in yield zones where agronomic factors will adversely affect the seed product's ability to achieve the predicted yield goal.

In some embodiments, the application generates a prescription using a computer system. The computer system receives yield data related to a plurality of population trials. The population trials include crop samples that are planted based on the variations of various parameters including, but not limited to a hybrid line being planted, a population density of the planting, and a spacing used between rows. The population samples are sown in the spring and are harvested upon ripening. Each trial of planting includes planting a crop such as corn in several plots, wherein each plot is defined as a small area of land. Each plot of land contains a sample population of the crop that is planted based on a combination of the above parameters. In an exemplary example, a trial may include sixteen hybrid varieties, five discrete population densities, and two discrete row spacings. It should be understood that any suitable combination of hybrid varieties, population densities, and row spacings may be used.

After the corn crop matures, the corn is harvested, and the yield for each plot per trial is recorded. The yield data thus obtained is extrapolated to yield a bushels per acre value for each plot based on the appropriate combination of hybrid line, population density, and row spacing. The yield results are grouped together based on factors such as geographical location, type of irrigation, and crop rotation. In some embodiments, the yield results are not grouped together based on geographical location, as described in more detail below.

Once the harvest data is recorded and grouped, the computer system analyzes the harvest data. For example, the yield data is input into a statistical modeling software to generate statistical predictive models. The predictive models thus obtained, are used to derive important mathematical correlations between yield data and various planting parameters such as the hybrid line, population density, and row spacing. An example of a predictive model obtained from such an analysis is a polynomial equation that includes a plurality of coefficients based on a population density component, an environment component, and a population interaction component that correlates the population density and environment components. Such an equation is generated for each combination of hybrid line and row spacing.

Moreover, in some embodiments, the computer system presents a user with a program user interface. The user inputs typical income and outgo values including, but not limited to only including, a number of acres planted, a market price per bushel for the crop, a land cost, a fertilizer cost, an insecticide cost, a fungicide cost, an herbicide cost, and any other overhead cost.

In addition, the user is also prompted to designate a data set. In some embodiments, the user selects from a dropdown list of regions in which the population trials were conducted. For example, the dropdown list may include selections for an entire state, a portion of a state, and portions of two or more adjacent states. In addition, the dropdown list may also include selections for aggregate regions that include data from one or more of the more localized selections. The user may also be presented with a second dropdown list that includes years during which the population trials were conducted. Moreover, in some embodiments, the user may configure the lists to include a subset of regions and/or years.

The computer system determines a predicted yield for each hybrid line in the selected data set after receiving acreage and cost information. More specifically, the computer system determines the predicted yield for each hybrid line at each row spacing and population density, and determines a predicted profit for each hybrid line in the selected data set based on acreage and cost information for each hybrid line at each row spacing and population density. The computer system then generates a crop prescription matrix, which is displayed to the user via, for example, a workstation or a mobile device.

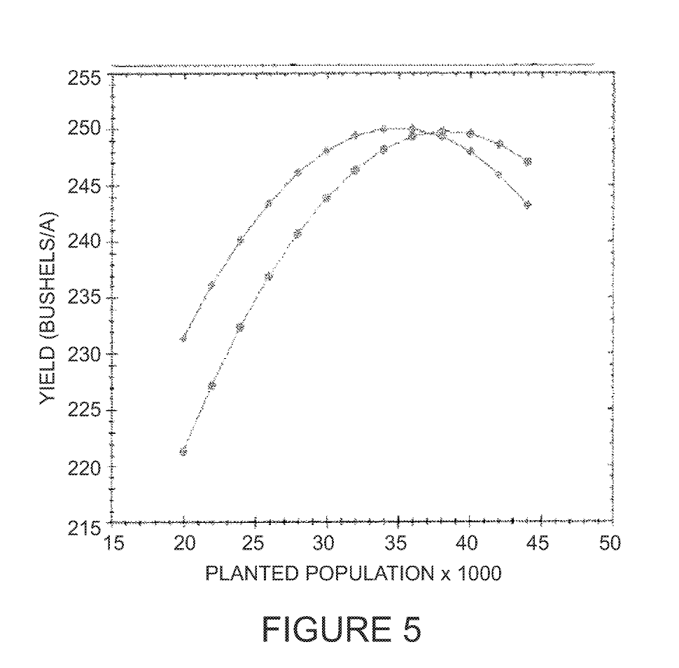

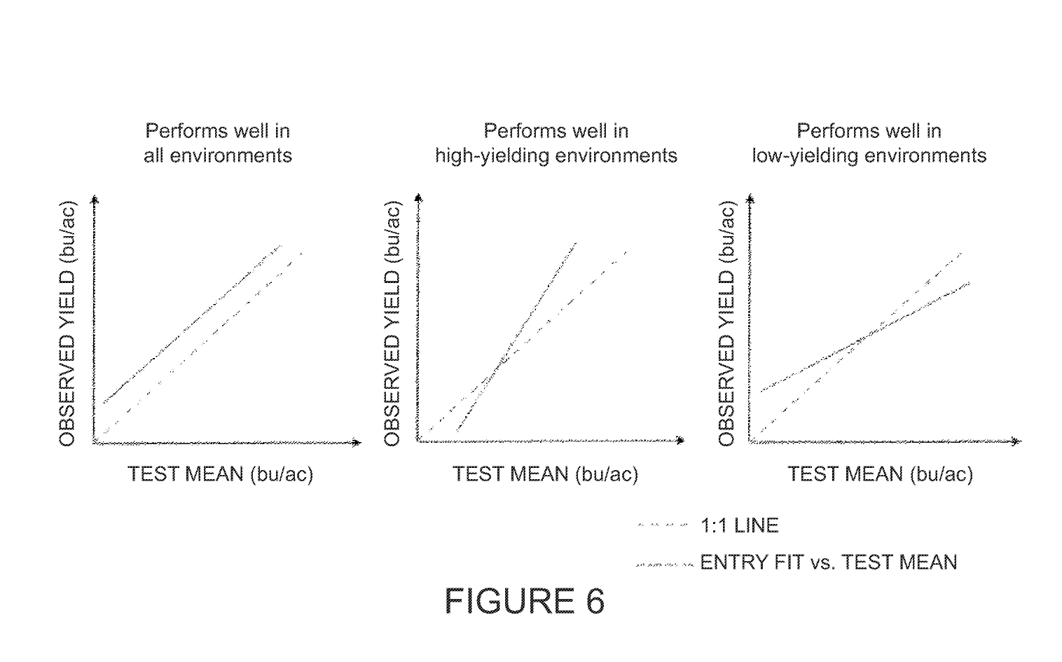

As shown in FIG. 5, yield and seeding rate equations are used during generation of the crop prescription to calculate a seeding rate recommendation that enables the grower to reach the yield goal for each yield zone. Moreover, as shown in FIG. 6, analyses of seed product performance in different yield ranges are used to assign a seed product to a yield zone to which it is best suited. Specifically, a seeding rate algorithm used by the computer system assigns a seed product and a seeding rate to each yield zone based on the calculated yield goal, a performance index and specific responses of the possible seed products, and/or varieties and cultivars to seeding rate and row width combinations. The seeding rate is calculated based on the plurality of crop population trials, and is inserted into the application via a series of empirically-determined regression models that are specific to each of a plurality of defined yield ranges. For example, corn hybrid may have yield ranges including 100-125 bushels/acres (bu/ac), 126-150 bu/ac, and greater than 250 bu/ac. However, any suitable crop may be used in the methods described herein. Moreover, any suitable hybrid crop may be used in the methods described herein. The performance index with an associated color coding system is used to rank and assign seed products, such as hybrid lines, to the yield zones based on models that identify seed products that have a performance at least that of the yield goal for each yield zone. The performance index is expressed as a number in a 1-100 scale, and rewards yield, low moisture at harvest, low lodging, and high test weight. Moreover, in some embodiments, the performance index is merged or interpolated with the soil brightness classification maps, green biomass index maps, and/or slope components.

In some embodiments, the computer system also calculates profitability index for use in the crop prescription, and enables the operator or user to determine a potential profitability of a seed product within each yield zone. The profitability index is expressed as a number in a 1-100 scale, and rewards a high price for a harvested product, and an absence of moisture and test weight discounts. The profitability index includes a slowed harvest penalty component that reflects lodging. The application display includes a user-operable toggle switch that enables the operator or user to manually specify a seeding rate that is higher or lower than the seeding rate recommendation.

In some embodiment, the application uses a preliminary information interview with the grower that obtains data related to seed product yield scenarios associated with the area of interest. The preliminary information interview is used to obtain local, technical knowledge for use in understanding the performance potential for seed products. The data is entered into the application by the operator or user via, for example, a security-enabled web site, and is stored into a memory area, such as a database.

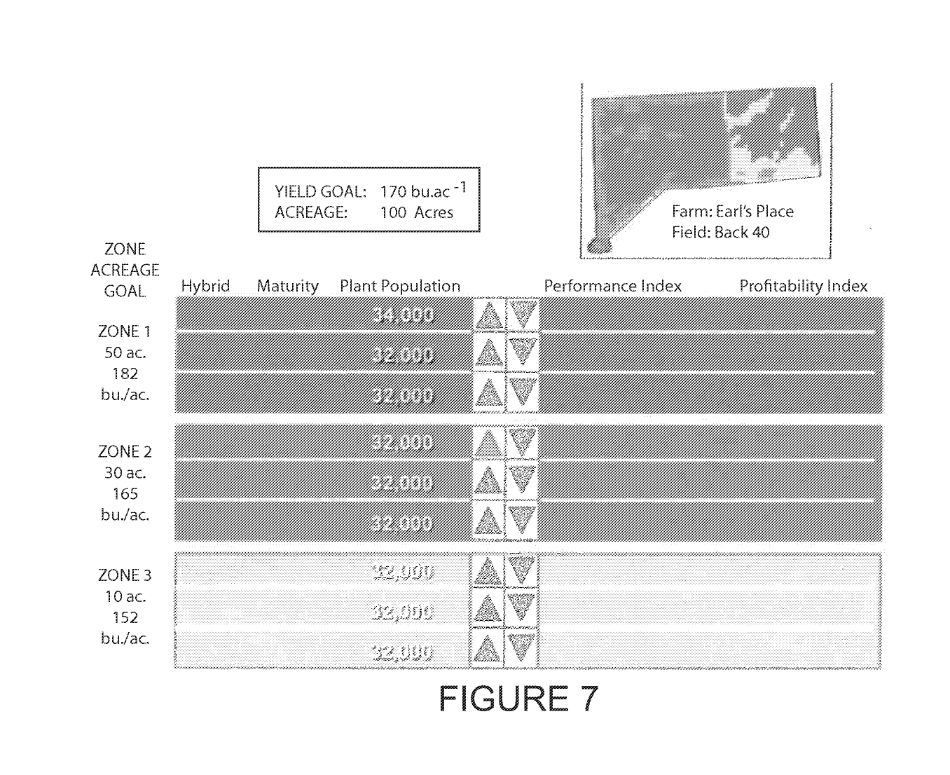

At least some of the data described above is used to generate the rule-making matrix that compares seed products and production scenarios. When a particular seed product is ranked for selection within a respective yield zone, the rule-making matrix is applied and positive and/or negative attributes of the seed product are displayed when compared with algorithmic results for the seed product. FIG. 7 is a view of an output screen that illustrates how a seed product recommendation and a seeding rate recommendation are displayed for each yield zone. Specifically, a qualitative suitability for the seed product within the respective yield zone is displayed to the operator or user via one of a plurality of icons, such as a red icon, a yellow icon, or a green icon. Each icon indicates to the operator or user whether the seed product is suitable for the yield zone, whether the seed product is not suitable for the yield zone, or whether use of the seed product may pose some problems to the grower. The display may be customized for individual growers. Moreover, the display facilitates rapid recognition of before and after seed product planting scenarios, enables toggling from field to field within the application, and includes a seed summary that quantifies a grower's seed needs.

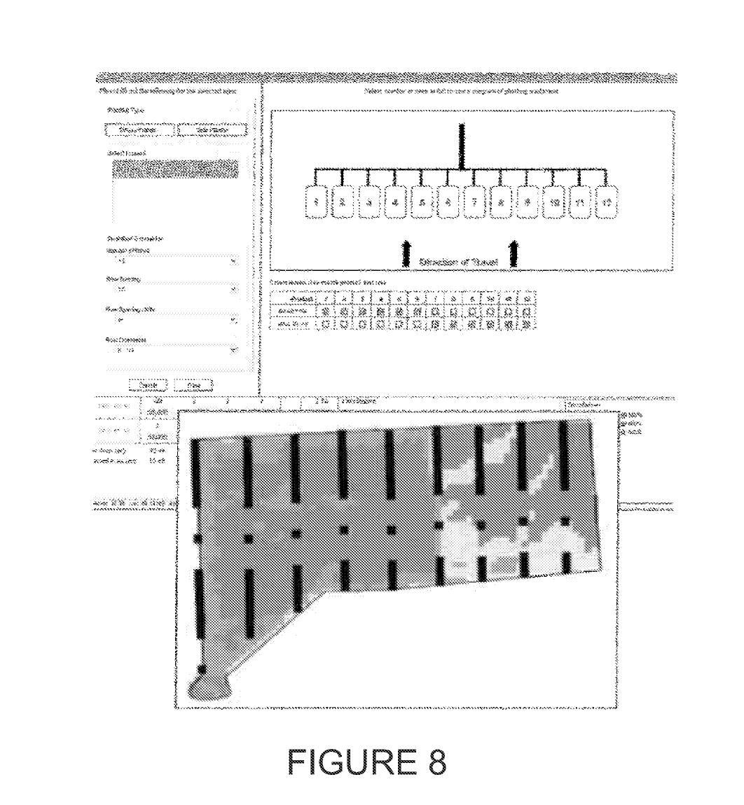

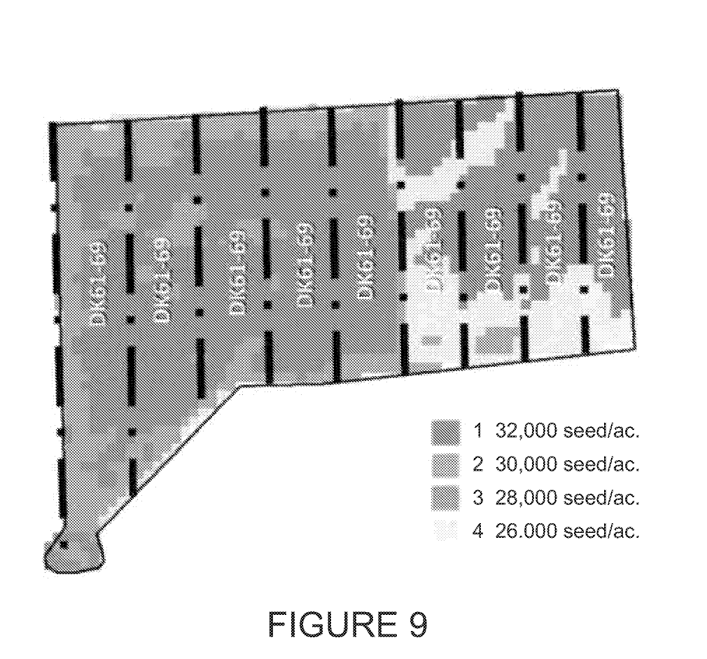

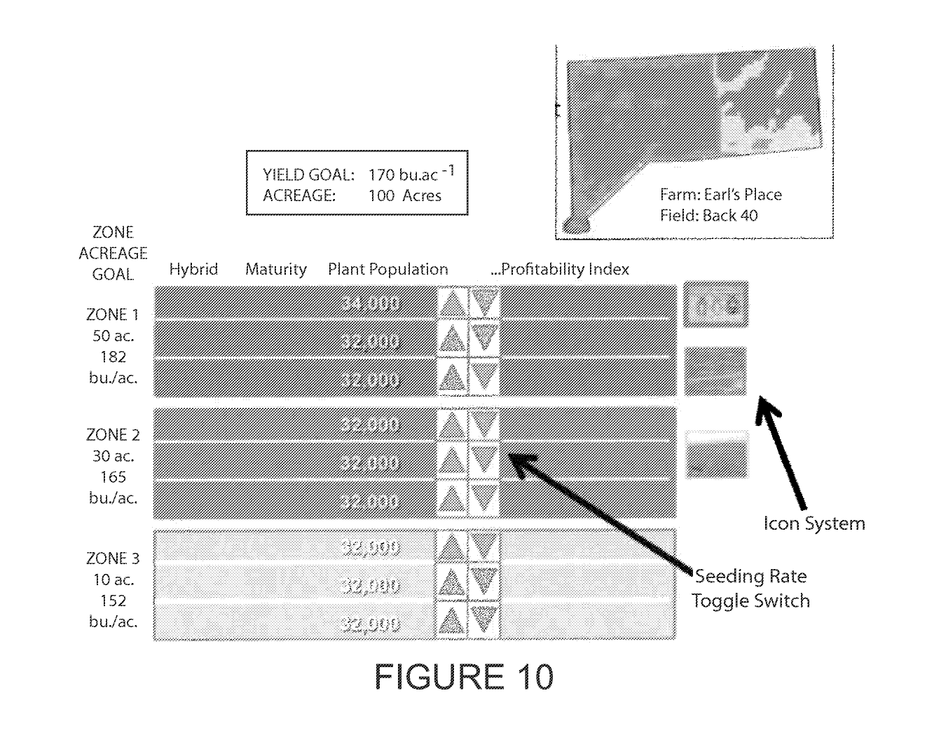

GIS software is used to present the digital map (shown in FIG. 7) to the operator or user that displays the seed product and seeding rate prescribed or selected for each yield zone. As shown in FIG. 8, the GIS software also displays a planter depiction that includes a plurality of hoppers. The operator or user uses a “drag and drop” process to specify a hopper for each seed product. Moreover, as shown in FIG. 9, the GIS software also includes a drawing tool that enables the operator or user to illustrate and/or overlay the planting recommendations onto the digital map. In addition, as shown in FIG. 10, an icon system is used to link specific seed product recommendations and agronomic scenarios that are considered when making the seed product recommendation. The planting recommendations are also stored into a memory or memory area.

The planting recommendations are delivered, such as electronically transmitted, to the grower for use in planting the area of interest. For example, the planting recommendation may be provided via an Internet download, a digital data card, and/or a wireless communication. During planting, data related to implementation of the planting recommendations by planting equipment is collected based on coordinates at which the planting equipment plants the selected seed products. More specifically, the planting recommendations are used, in algorithmic form, to direct a controller that provides instructions to the planting equipment such that the selected seed product is planted at the selected seeding rate within the specified yield zones. Accordingly, the application described herein enables use of variable rate seeding across different yield zones. The coordinates may be collected using Global Positioning System (GPS), GIS digital map, or radio frequency identification (RFID) technologies. The implementation data is transmitted to the operator or user of the application described herein, and is stored in the memory area.

Exemplary embodiments of methods, systems, computers, and computer-readable storage media for use in enhancing crop performance are described above in detail. The methods, systems, computers, and storage media are not limited to the specific embodiments described herein but, rather, operations of the methods and/or components of the system and/or apparatus may be utilized independently and separately from other operations and/or components described herein. Further, the described operations and/or components may also be defined in, or used in combination with, other systems, methods, and/or apparatus, and are not limited to practice with only the systems, methods, and storage media as described herein.

A computer or server, such as those described herein, includes at least one processor or processing unit and a system memory. The computer or server typically has at least some form of computer readable media. By way of example and not limitation, computer readable media include computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although the present invention is described in connection with an exemplary agronomic system environment, embodiments of the invention are operational with numerous other general purpose or special purpose agronomic system environments or configurations. The agronomic system environment is not intended to suggest any limitation as to the scope of use or functionality of any aspect of the invention. Moreover, the agronomic system environment should not be interpreted as having any dependency or requirement relating to any one or combination of components illustrated in the exemplary operating environment. Examples of well known agronomic systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program components or modules, executed by one or more computers or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, the term “processor” refers generally to any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, the term “database” refers generally to any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

When introducing elements of aspects of the invention or embodiments thereof, the articles “a,” “an,” “the,” and “said” are intended to mean that there are one or more of the elements. The terms “comprising,” including,” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for enhancing crop performance using a computer coupled to a memory, the method comprising:
receiving a plurality of area of interest (AOI) raster files from a remote sensing device via a network;
generating at least one index raster file based on the plurality of AOI raster files;
defining at least one yield zone within the AOI based on the at least one index raster file;
determining a hybrid and a seed rate for the hybrid for use in planting in the at least one yield zone;
generating a planting recommendation for the AOI based on the hybrid and the seed rate; and
delivering the planting recommendation to a planter, wherein the planter is configured to plant the at least one yield zone using the hybrid and the seed rate.

2. The method in accordance with claim 1, further comprising calculating a yield goal for the at least one yield zone based on a plurality of population trials.

3. The method in accordance with claim 2, wherein determining a hybrid and a seed rate comprises determining the hybrid and calculating the seed rate based on the plurality of population trials.

4. The method in accordance with claim 3, wherein determining the hybrid rate comprises:
calculating a rank of each of a plurality of hybrids used in the plurality of population trials; and
using a rules matrix to determine the hybrid for use in the at least one yield zone.

5. The method in accordance with claim 3, wherein determining the hybrid comprises calculating a profitability index of each of a plurality of hybrids used in the plurality of population trials.

6. The method in accordance with claim 1, wherein determining a hybrid and a seed rate comprises receiving the seed rate via user input into the computer.

7. The method in accordance with claim 1, wherein generating a planting recommendation comprises generating a map for display by the computer, wherein the map designates a position of the at least one yield zone within the AOI and identifies the hybrid and the seed rate for use within the at least one yield zone.

8. The method in accordance with claim 1, wherein delivering the planting recommendation comprises electronically transmitting the planting recommendation to the planter.

9. The method in accordance with claim 1, further comprising:
receiving position data of the planter during planting of the hybrid; and
storing the planting recommendation and the position data in the memory area.

10. A computer coupled to a memory area for use in enhancing crop performance, the computer programmed to:
receive a plurality of area of interest (AOI) raster files from a remote sensing device via a network;
generate at least one index raster file based on the plurality of AOI raster files;
define at least one yield zone within the AOI based on the at least one index raster file;
determine a hybrid and a seed rate for the hybrid for use in planting in the at least one yield zone based on a plurality of population trials;
generate a planting recommendation for the AOI based on the hybrid and the seed rate;
deliver the planting recommendation to a planter, wherein the planter is configured to plant the at least one yield zone using the hybrid and the seed rate;
receive position data of the planter during planting of the hybrid; and
store the planting recommendation and the position data in the memory area.

11. The computer in accordance with claim 10, further programmed to calculate a yield goal for the at least one yield zone based on the plurality of population trials.

12. The computer in accordance with claim 10, further programmed to:
calculate a rank of each of a plurality of hybrids used in the plurality of population trials;
calculate a profitability index of each of the plurality of hybrids; and
use a rules matrix to determine the hybrid for use in the at least one yield zone.

13. The computer in accordance with claim 10, further programmed to receive the seed rate via user input into the computer.

14. The computer in accordance with claim 10, further programmed to generate a map for display by a display device, wherein the map designates a position of the at least one yield zone within the AOI and identifies the hybrid and the seed rate for use within the at least one yield zone.

15. The computer in accordance with claim 10, further programmed to deliver the planting recommendation using an electronic transmission.

16. One or more computer-readable storage media having computer-executable components for enhancing crop performance within an area of interest (AOI) using a computer coupled to a memory area, the components comprising:
an index component that when executed by at least one processor causes the at least one processor to:
receive a plurality of AOI raster files from a remote sensing device via a network; and
generate at least one index raster file based on the plurality of AOI raster files;
a yield zone component that when executed by at least one processor causes the at least one processor to:
define at least one yield zone within the AOI based on the at least one index raster file; and
calculate a yield goal for the at least one yield zone based on a plurality of population trials; and
a planting recommendation component that when executed by at least one processor causes the at least one processor to:
determine a hybrid and a seed rate for the hybrid for use in planting in the at least one yield zone based at least in part on the yield goal;
generate a planting recommendation for the AOI based on the hybrid and the seed rate; and
transmit the planting recommendation to a planter, wherein the planter is configured to plant the at least one yield zone using the hybrid and the seed rate.

17. The computer-readable storage media in accordance with claim 16, wherein the planting recommendation component determines the hybrid and calculates the seed rate based on the plurality of population trials.

18. The computer-readable storage media in accordance with claim 16, wherein the planting recommendation component:
calculates a rank of each of a plurality of hybrids used in the plurality of population trials; and
uses a rules matrix to determine the hybrid for use in the at least one yield zone.

19. The computer-readable storage media in accordance with claim 16, wherein the planting recommendation component calculates a profitability index of each of a plurality of hybrids used in the plurality of population trials.

20. The computer-readable storage media in accordance with claim 16, wherein the planting recommendation component receives the seed rate via user input into the computer.

21. The computer-readable storage media in accordance with claim 16, wherein the planting recommendation component generates a map for display by the computer, wherein the map designates a position of the at least one yield zone within the AOI and identifies the hybrid and the seed rate for use within the at least one yield zone.

22. A system configured to enhance crop performance within an area of interest (AOI), the system comprising:
a computer system comprising a memory and a processor coupled to the memory, the computer system coupled to a remote sensing device via network, wherein the computer system is configured to:
receive a plurality of AOI raster files from a remote sensing device via a network;
generate at least one index raster file based on the plurality of AOI raster files;
define at least one yield zone within the AOI based on the at least one index raster file;
calculate a yield goal for the at least one yield zone based on a plurality of population trials;
determine a hybrid and a seed rate for the hybrid for use in planting in the at least one yield zone based at least in part on the yield goal;
generate a planting recommendation for the AOI based on the hybrid and the seed rate; and
transmit the planting recommendation to a planter, wherein the planter is configured to plant the at least one yield zone using the hybrid and the seed rate.

23. The system in accordance with claim 22, wherein the computer system is further configured to:
calculate a rank of each of a plurality of hybrids used in the plurality of population trials; and
use a rules matrix to determine the hybrid for use in the at least one yield zone.

24. The system in accordance with claim 22, wherein the computer system is further configured to calculate a profitability index of each of a plurality of hybrids used in the plurality of population trials.

25. The system in accordance with claim 22, wherein the computer system is further configured to receive the seed rate via user input.

26. The system in accordance with claim 22, wherein the computer system is further configured to generate a map for display to a user, wherein the map designates a position of the at least one yield zone within the AOI and identifies the hybrid and the seed rate for use within the at least one yield zone.

27. The system in accordance with claim 22, wherein the computer system is further configured to:
receive position data of the planter during planting of the hybrid; and
store the planting recommendation and the position data in the memory.
